(19) United States
(12) Patent Application Publication
(10) Pub. No.: US 2024/0152776 A1
(43) Pub. Date: May 9, 2024

(54) Utilizing Slope Features for Temporally Spaced Data

(71) Applicant: PayPal, Inc., San Jose, CA (US)

(72) Inventors: Romil Varadkar, Bangalore (IN); Logasundari Vinayagam, Fremont, CA (US); Ashok Subash, Chennai (IN); Suraj Arulmozhi, Chennai (IN); Parvathavarthini Raman, Chennai (IN); SRIMATHY M, Chennai (IN); Harini Shekar, Chennai (IN); Deepak Mohanakumar Chandramouli, San Jose, CA (US)

(21) Appl. No.: 18/054,003

(22) Filed: Nov. 9, 2022

(51) Int. Cl. G06N 5/022

(52) U.S. Cl. CPC G06N 5/022

(57) ABSTRACT

Techniques for the implantation of time-dependent features (e.g., slope features) in existing data analysis models are disclosed. Time-dependent features are applied in machine learning algorithms to provide deeper analysis of temporally spaced data. Temporally spaced data is time-based or time-dependent data where data is populated at different points in time over some period of time. Implementing the time-dependent features enables application of first derivatives that define slopes over time (e.g., performance) windows within the period of time of the data. Application of the first derivatives provides analysis of the trend of the data over time. Additional features and/or higher order derivatives may also be applied to the first derivatives to provide further refinement to analysis of the temporally spaced data.

### BACKGROUND

### Technical Field

This disclosure relates generally to feature engineering architecture improvements for machine learning, including methods of adding slope feature variables to machine learning algorithms to capture temporal trends, according to various embodiments.

### Description of the Related Art

Data analysis models implement machine learning algorithms (e.g., neural networks and decision-tree based models) to provide predictions on input data in many different utilizations. For example, data analysis models can be implemented to analyze data and determine patterns in the data from which predictions can be made. In many instances, the input data is data accumulated over a period of time (e.g., the data is temporal data). Various variables (e.g., features) can be implemented in a data analysis model by operators of the model in order to provide predictions desired for a certain use case. These variables are often aggregate features that look at absolute values of data. Relying primarily on aggregate features may, however, miss trends in temporally spaced data that can be useful in providing more accurate predictions from the data analysis model.

### BRIEF DESCRIPTION OF THE DRAWINGS

FIG. 1 is a block diagram of a system for determining a decision based on assessment of a dataset of temporally spaced data, according to some embodiments.

FIG. 2 is a block diagram of a machine learning module, according to some embodiments.

FIG. 3 depicts an example dataset having data values accumulated over a six month time period.

FIG. 4 depicts an example of different categories being labelled for each time window of the example of FIG. 3.

FIG. 5 depicts an example of an overlap between time windows.

FIG. 6 depicts an example of a potential derivative tree based on specified number of time windows, according to some embodiments.

FIG. 7 depicts a flow diagram illustrating a method for implementing time-dependent features in an existing data analysis model, according to some embodiments.

FIG. 8 depicts a flow diagram illustrating a method for implementing time-dependent features in an existing data analysis model with a time-dependent features engine, according to some embodiments.

FIG. 9 is a flow diagram illustrating a method for applying time-dependent features in analysis of temporally spaced data by a machine learning algorithm, according to some embodiments.

FIG. 10 is a block diagram of one embodiment of a computer system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z). In some situations, the context of use of the term “or” may show that it is being used in an exclusive sense, e.g., where “select one of x, y, or z” means that only one of x, y, and z are selected in that example.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION

The present disclosure is directed to various techniques related to the implementation of slope features in data analysis models. Data analysis models are used in a wide variety of applications to provide outputs based on data input into the models. Outputs of data analysis models may include, but not be limited to, predictive outputs and classification outputs. The models analyze patterns in the input data and provide desired outputs designed based on programming of the model. Programming a data analysis model may include, for example, applying specific features (e.g., variables) to the model. Features are applied to the model to add calculations (e.g., define data analysis functions) in the model that tell the model what patterns to look for in the data (e.g., what calculations to make in analyzing the data). Data analysis models often include large numbers of features that determine how and what predictions are made by the models.

One example use of data analysis models is in making risk assessment predictions or risk assessment decisions. Variables related to assessment of risk for an operation associated with a user may be programmed into a data analysis model. The data analysis model may then determine predictions of risk provided based on input data (such as customer data) in order to make a risk assessment decision for an operation associated with the customer. As used herein, “risk assessment” refers to an assessment of risk associated with conducting an operation. In this context, “an operation” can be any tangible or non-tangible operation involving one or more sets of data associated with a user or a group of users for which there may be some potential of risk. Examples of operations for which risk assessment decisions can be made include, but are not limited to, transactional operations (such as credit card operations), investment operations, insurance operations, and robotic operations. As a specific example, risk of fraud or loss may be assessed for transactional operations or investment operations.

In many instances, data analysis models are implemented to make predictions (e.g., decisions) based on temporally spaced data. As used herein, “temporally spaced data” refers to data that includes data values that are collected or populated at different points in time over some period of time. For instance, temporally spaced data may be data that includes data values populated for an item where the data values are populated at different points in time (e.g., time points) over a specified time period. The different points in time for population of data values may thus be referred to as “temporally spaced data points”. Temporally spaced data may, for example, be data for an item that is populated at intervals over a specified time period (e.g., over a period of minutes, days, months, years, etc.). As a specific example, temporally spaced data for an item may include data with data points populated at monthly intervals over a period of a year. Thus, the temporally spaced data includes twelve values for the item with each value being populated for a specific month during the year. Temporally spaced data may sometimes be referred to as “time-based data” or “time-differentiated data”.

Many data analysis models implement aggregate features (e.g., aggregate variables) in the analysis of temporally spaced data. Aggregate features are features that provide analysis of overall performance of a data value over a period of time. Examples of aggregate features include, but are not limited to, count number over the time period (e.g., number of data points), minimum value over the time period, maximum value over the time period, average value over the time period, and median value over the time period. While utilizing aggregate features in the data analysis models provide useful information about the data, relying only on aggregate features utilization for data analysis may miss time-based trends in the data that provide important information. For instance, with only aggregate features, trends in changes in data values over time during the time period can be missed.

Some alternative methods have been attempted to try to capture time-based trends in temporally spaced data. One example is the use of a convolutional neural network (CNN) and max pooling. CNN utilizes matrix multiplication. Matrix multiplication, however, is not time-based trend sensitive and multiple combinations can lead to the same output. Max pooling further dampens any trends as it is typically implemented to emphasize high points in the data no matter where the high points occur.

The present disclosure contemplates various features that may be implemented in data analysis models to capture time-based trends in data values. Additionally, the present disclosure contemplates various techniques for implementing the features in data analysis models such as machine learning algorithms. One embodiment described herein has two broad components: 1) accessing a dataset that includes temporally spaced data (e.g., data that includes data values populated at different time points over a period of time) and 2) applying a machine learning algorithm to the dataset wherein the machine learning algorithm applies at least one time-dependent feature to the dataset. As used herein, the term “time-dependent feature” refers to a feature that provides some analysis of time-based changes in data values. A time-dependent feature may sometimes be referred to as a “time trend feature” or a “time-sensitive feature”.

In various embodiments, time-dependent features are slope features. Slope features may be applied into the data analysis models as derivatives. For instance, a first derivative may be implemented to define a slope that corresponds to a change in a data value between two points in time (e.g., two time points). For temporally spaced data, the slope defines changes in data values (plotted on the y-axis) versus time (plotted on the x-axis). In certain embodiments, first derivatives are determined for multiple time windows within an overall time period for a set of temporally spaced data. As used herein, the term “time window” refers to a window of time between two time points in a temporally spaced dataset. In some instances, a time window may be referred to as a “performance window”.

In certain embodiments, a time window is defined by a user-defined hyperparameter applied to a data analysis model. With multiple time windows in the overall time period for a dataset, multiple first derivatives may be determined (e.g., a first derivative is determined for each time window). The data analysis model may then be capable of grabbing or understanding time-based trends in the data based on analysis of the first derivatives since the first derivatives provide analysis of trends in different time windows.

In some embodiments, additional higher order derivatives (e.g., second derivatives, third derivatives, etc.) are implemented to provide deeper analysis of trends in the data over time by gaining insight into changes over time in lower order derivatives. For example, second derivatives may define changes in first derivatives, third derivatives may define changes in second derivatives, etc. The number of higher order derivatives available may be determined based on the number of time windows present within a dataset. For instance, at least two time windows are need for one second derivative to be available and at least three time windows are needed for one third derivative to be available.

In short, the present inventors have recognized the benefits of applying time-dependent features (e.g., slope features) in data analysis models to provide deeper insights into temporally spaced data. Applying time-dependent features to existing data analysis models provides the models with new tools that allow the models to operate in new ways. For example, data analysis models that implement time-dependent features are capable of capturing (e.g., grabbing or analyzing) data differently than if only aggregate features are implemented. Adding time-dependent features adds calculations to the data analysis models that capture time-based trends in the data in addition to overall (e.g., absolute) trends in the data over a time period of interest. Accordingly, adding time-dependent features (e.g., slope features) to data analysis models provides deeper insights into time-sensitive data such as temporally spaced data. Providing deeper insights into the data may then allow the data analysis models to provide more accurate and precise predictions (such as predictions of risk).

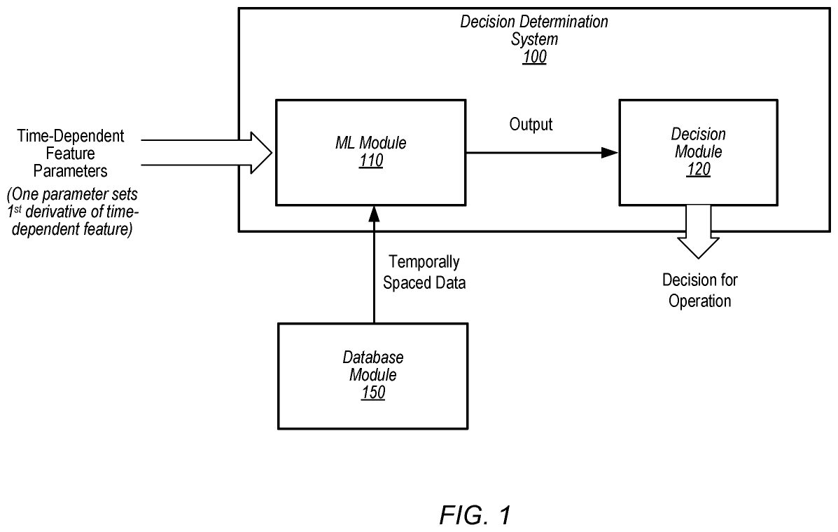

FIG. 1 is a block diagram of a system for determining a decision based on assessment of a dataset of temporally spaced data, according to some embodiments. In the illustrated embodiment, decision determination system 100 includes machine learning (ML) module 110 and decision module 120. Decision determination system 100 may be implemented by one or more computing systems. As used herein, the term “computing system” refers to any computer system having one or more interconnected computing devices. Note that generally, this disclosure may include various examples and discussion of techniques and structures within the context of a “computer system.” Note that all these examples, techniques, and structures are generally applicable to any computing system that provides computer functionality. The various components of a computing system (e.g., computing devices) may be interconnected. For instance, the components may be connected via a local area network (LAN). In some embodiments, the components may be connected over a wide-area network (WAN) such as the Internet.

In various embodiments, ML module 110 accesses temporally spaced data from database module 150. Database module 150 may be a data store or any other data storage that is capable of receiving and storing temporally spaced data (e.g., “time-based data” or “time-differentiated data”), described herein. For instance, database module 150 may be a data store that receives, and stores time-stamped user data associated with a service system. In some embodiments, database module 150 may be a real-time provider of data to ML module 110. For instance, database module 150 may handle data that can be accessed in real-time by ML module 110.

In certain embodiments, as shown in FIG. 1, time-dependent feature parameters are provided to ML module 110. In various embodiments, time-dependent feature parameters are hyperparameters that are tuned to provide desired outputs from ML module 110. For instance, the hyperparameters may be tuned to one or more specific use cases associated with ML module 110 based on historical data for the specific use cases. The hyperparameters may be tuned, for example, by data scientists with knowledge of the specific use case(s). In various embodiments, ML module 110 determines time-dependent features to apply in data assessment (e.g., calculations on data) based on the time-dependent feature parameters provided to the ML module. ML module 110 may apply the time-dependent features along with other features (such as aggregate features).

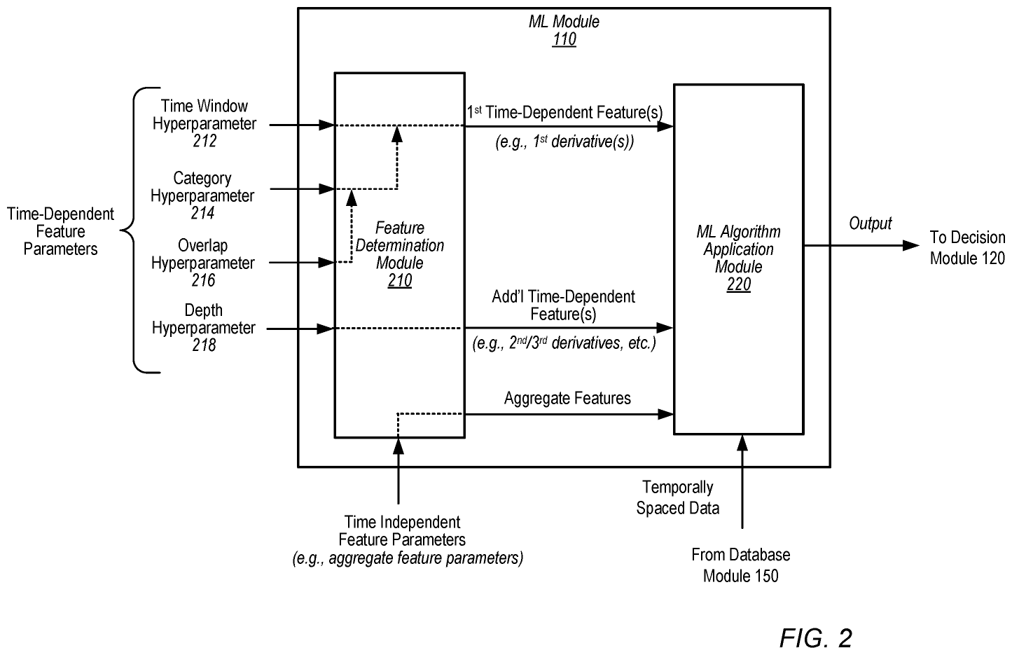

FIG. 2 is a block diagram of ML module 110, according to some embodiments. In the illustrated embodiment, ML module 110 includes feature determination module 210 and ML algorithm application module 220. In certain embodiments, the time-dependent feature parameters (e.g., hyperparameters) are provided to feature determination module 210. Examples of time-dependent feature parameters that may be provided include, but are not limited to, a time (e.g., performance) window hyperparameter 212, a category (e.g., path) hyperparameter 214, an overlapping window hyperparameter 216, and a depth hyperparameter 218.

In certain embodiments, time window hyperparameter 212 is utilized by feature determination module 210 to define one or more first time-dependent features (e.g., “first derivatives) that are implemented by ML algorithm application module 220 (as shown by the dotted line through feature determination module 210 in FIG. 2). For example, feature determination module 210 may implement time window hyperparameter 212 to set the windows in time over which one or more first derivatives (e.g., slope) are applied to a set of data by ML algorithm application module 220. As used herein, the “first derivative” is a slope that corresponds to a change in a data value between two points in time (e.g., “time points”). Accordingly, feature determination module 210 implements time window hyperparameter 212 to set the time points within an overall time period for a dataset where the time points divide the overall time period into different time windows.

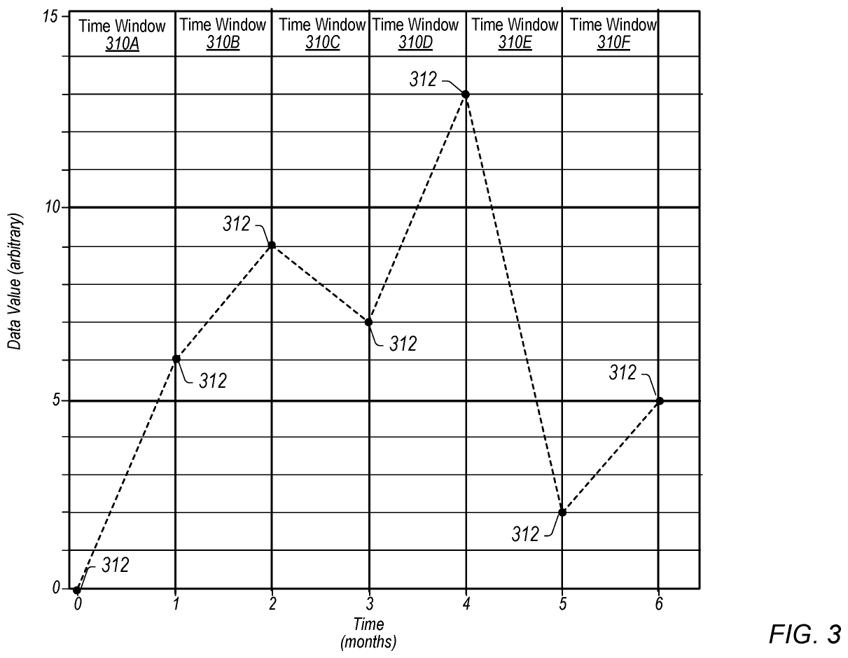

As an example, we turn to FIG. 3, which depicts an example dataset having data values accumulated over a six month time period. With the overall time period for the dataset being six months, the time window hyperparameter 212 can set a time window 310 as a period of a month. Accordingly, the time points 312 will be set at every month and there will be six time windows (310A-F) within the overall time period, as shown in FIG. 3. With the six time windows, there will be six first derivatives applied to the dataset with each first derivative being the slope between the monthly time points 312.

The time windows set for a dataset are typically smaller windows in time than the overall time period of the dataset. For instance, in the above example, the time window hyperparameter 212 sets the time windows to be individual months for the dataset having the overall time period of six months. With these time windows set by feature determination module 210, ML algorithm application module 220 will apply six first derivatives in its analysis of the dataset to determine the output for ML module 110.

In various embodiments, time window hyperparameter 212 is determined based on the dataset being analyzed and the type of information wanted from the dataset (e.g., the specific use case desired). The time window hyperparameter 212 may be tuned to provide confident analysis of time-based trends in the data. Incorrect tuning of time window hyperparameter 212 may reduce the effectiveness of ML algorithm application module 220 in determining the output. For instance, generally larger time windows may be implemented for more consistent data in order to capture any trends while more dynamic data may need smaller time windows. Care may also be taken when tuning the time window hyperparameter 212 as setting too large a time window may cancel out highs and lows (e.g., changes in data will be missed) while setting too small a time window may create too much noise in the first derivative data, potentially leading to inconclusive results.

Turning back to FIG. 2, in some embodiments, category hyperparameter 214 or overlapping window hyperparameter 216 are provided to feature determination module 210 to define various additions or adjustments to the first time-dependent features (e.g., the first derivatives). In certain embodiments, category hyperparameter 214 is a parameter implemented by feature determination module 210 to set and define (e.g., labels) a number of categories (e.g., paths) for a data value to be labelled with within a time window. For instance, categories could be defined and labelled to define different characteristics of the data within a time window. The labels may be, for example, descriptive labels about the behavior of data within the time window. Specific examples of category behaviors that may be labelled include, but are not limited to, drops (e.g., high, low, marginal, etc.), growth (e.g., calculated, measured, ambitious, exponential, etc.), or sustain in value.

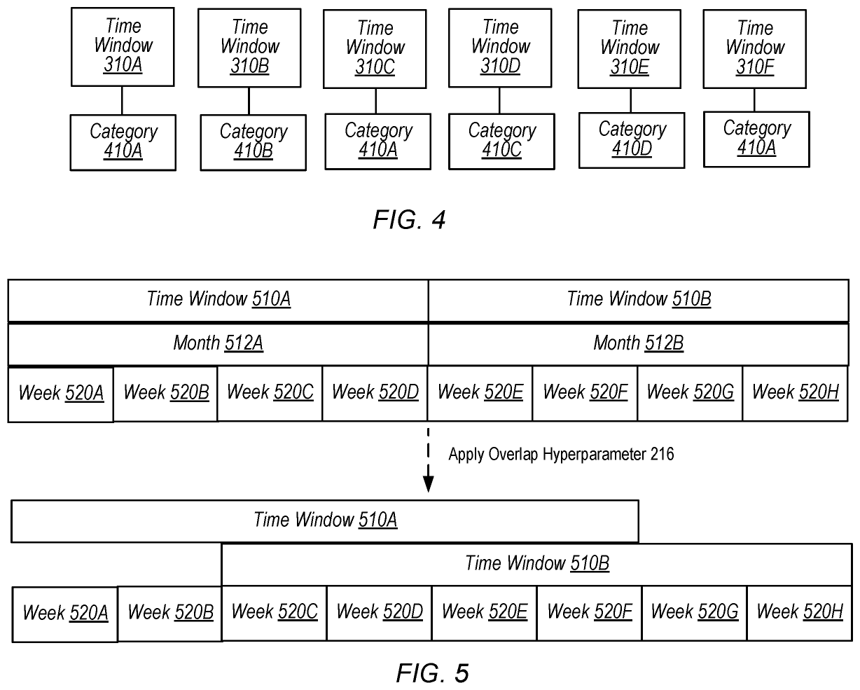

FIG. 4 depicts an example of different categories being labelled for each time window of the example of FIG. 3. In the illustrated example, time window 310A is labelled with category 410A, time window 310B has category 410B, time window 310C has category 410A, time window 310D has category 410C, time window 310E has category 410D, and time window 310F has category 410A. Adding the application of categories to first derivative features in ML algorithm application module 220 may provide deeper insight into the data and more accurate predictions and outputs. For instance, for financial applications, different combinations of drop, growth, and sustain over successive first derivatives (e.g., successive time windows) may be indicative of certain patterns in the data.

Turning back again to FIG. 2, overlapping window hyperparameter 216 is a parameter implemented by feature determination module 210 to allow time windows to be overlapped in the first time-dependent features (e.g., the first derivatives include overlapping time windows). In certain embodiments, overlapping window hyperparameter 216 sets an overlap between specific time windows. For instance, FIG. 5 depicts an example of an overlap between time windows 510A and 510B. In the illustrated embodiment, time window 510A is originally set by time window hyperparameter 212 as month 512A that includes weeks 520A-D and month 512B is originally set by time window hyperparameter 212 as subsequent month 512B that includes weeks 520E-H. The addition to the feature provided by overlapping window hyperparameter 216 is to overlap weeks 520C, 520D, 520E, and 520F between the two time windows 510A, 510B. This changes time window 510A to include weeks 520A-F and time window 510B to include weeks 520C-520H. Thus, weeks 520C, 520D, 520E, and 520F are included in both the first derivative applied according to time window 510A and the first derivative applied according to time window 510B. Overlapping window hyperparameter 216 may be applied to cover abnormalities in data. For example, overlapping window hyperparameter 216 may be applied to minimize the impact of isolated periods of abnormal data. As a specific example, overlapping window hyperparameter 216 may be applied to shopping-based data to minimize the impact of higher shopping seasons such as holiday seasons.

In some embodiments, as shown in FIG. 2, depth hyperparameter 218 is provided to feature determination module 210. Depth hyperparameter 218 may determine the number of higher order derivatives applied by feature determination module 210. For instance, depth hyperparameter 218 may indicate that feature determination module 210 is to apply up to, n, number of derivative levels (e.g., a total number of levels of higher derivative orders). After the first derivatives, the next order of derivatives are the second derivatives. Second derivatives are derivatives that defines a change in the slope between two first derivatives. For example, using the time windows 310 depicted in FIG. 3, a second derivative may define a change in the slope between time window 310A and time window 310B (e.g., the change between the first derivative of time window 310A and the first derivative of time window 310B). Another second derivative may then define a change in the slope between time window 310B and time window 310C with additional second derivatives for each additional changes in time windows. It should be understood that the number of second derivatives is one less than the number of first derivatives. Thus, the number of second derivatives is one less than the number of time windows set by time window hyperparameter 212.

Third, fourth, and higher derivatives similarly can be implemented to represent the change in the lower derivative (e.g., third derivative defines change in second derivative). It should be understood that the actual number of derivative levels that may be applied is determined by the number of time windows implemented for a dataset (e.g., the number of first derivatives determines the highest order of derivatives available). For instance, if there are x number of first derivatives, then there are (x) order of derivatives available (n=x) since a higher order derivative needs at least two of the lower order derivative (e.g., a second derivative needs two first derivatives, a third derivative needs two second derivatives, etc.).

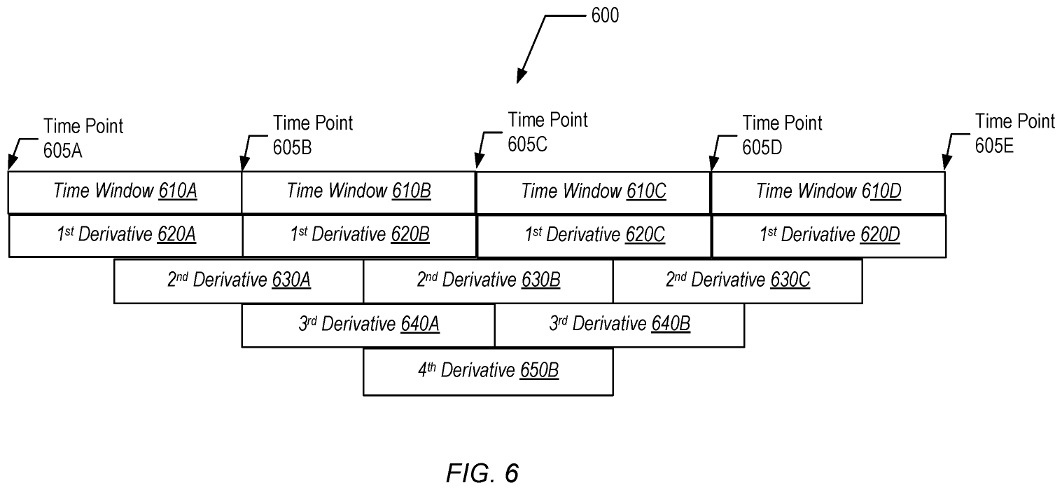

FIG. 6 depicts an example of a potential derivative tree based on specified number of time windows, according to some embodiments. In the illustrated embodiment, tree 600 includes five time points (time points 605A-E) that define four time windows 610A-D (which are set by time window hyperparameter 212, described herein). As there are five time points 605A-E and four time windows 610A-D, there are four first derivatives available (e.g., first derivatives 620A-D). With four first derivatives 620A-D, there can be three second derivatives 630A-C. With three second derivatives 630A-C, there are then two third derivatives 640A, 640B and one fourth derivative 650B available.

The addition of higher order derivatives provides further insight into the data as changes in changes are defined and applied in the analysis of the data. For example, applying second order derivatives may be about 3 times for significant in explaining data than absolute features (e.g., aggregate features). Adding higher order derivatives may, however, increase computational needs. Thus, the number of higher order derivatives may be limited to maintain efficiency in determining calculations and providing output from ML module 110.

In various embodiments, as shown in FIG. 2, time independent feature parameters (e.g., aggregate feature parameters) may be provided in addition time-dependent feature parameters for application in ML module 110. Feature determination module 210 may then provide aggregate features for application in ML algorithm application module 220. Aggregate features may include, for example, absolute features such as, but not limited to, a feature defining an average value for data values over the period of time, a feature defining a maximum value for data values over the period of time, and a feature defining a minimum value for data values over the period of time.

In the illustrated embodiment, ML algorithm application module 220 receives the time-dependent features and the aggregate features and applies these features to temporally spaced data access from database module 150 in various calculations to provide the output to decision module 120. In some embodiments, ML algorithm application module 220 implements a classification machine learning algorithm and the output is a classification category output. One example of a classification machine learning algorithm is a convolutional neural network algorithm. In some embodiments, ML algorithm application module 220 implements a predictive machine learning algorithm and the output is a predictive output. One example of a predictive machine learning algorithm is a decision tree algorithm. Embodiments for continuous use cases may also be contemplated.

Turning now back to FIG. 1, the output from ML module 110 is provided to decision module 120. Decision module 120 may then determine a decision based on the output provided by ML module 110. For example, for a risk assessment, the output of ML module 110 may be a prediction of risk associated with a user based on a dataset of temporally spaced data for the user accessed from database module 150. From this prediction of risk, decision module 120 may then make a determination of whether to accept the risk and allow a user request (e.g., a financial transaction request) to process or to reject the user's request based on the risk being too high. Decision module 120 may, however, implement decisions based on any time-based metric that involves temporally spaced data (e.g., data that populates over time).

As described herein, ML module 110 implements time-dependent features in making assessments of temporally spaced data. The implementation of time-dependent features (e.g., slope features) in the assessment of temporally spaced data allows for assessment of the trends in the data over time (e.g., time-based trends in the data). Assessment of time-based trends provides further insight into the data than allowed by the application of simple aggregate features (e.g., absolute features), which are limited in their insight by only seeing absolute values of the data over an entire time period of data.

The implementation of time-dependent features described herein is provided for existing models (e.g., existing machine learning models) to allow the models to operate in new and different ways to provide deeper analysis of temporally spaced data. The deeper analysis may provide more accurate predictions of outcomes. With the more accurate predictions, better decisions can be made based on temporally spaced data. For example, risk or fraud assessments may be more accurate when time-based trends are analyzed in customer data. Accordingly, the implementation of time-dependent features into existing data analysis models provides increased accuracy and precision when applied to temporally spaced data over current methods such as sequential models such as LSTM (long short-term memory) models, convolutional neural network (CNN) models, and max pooling models.

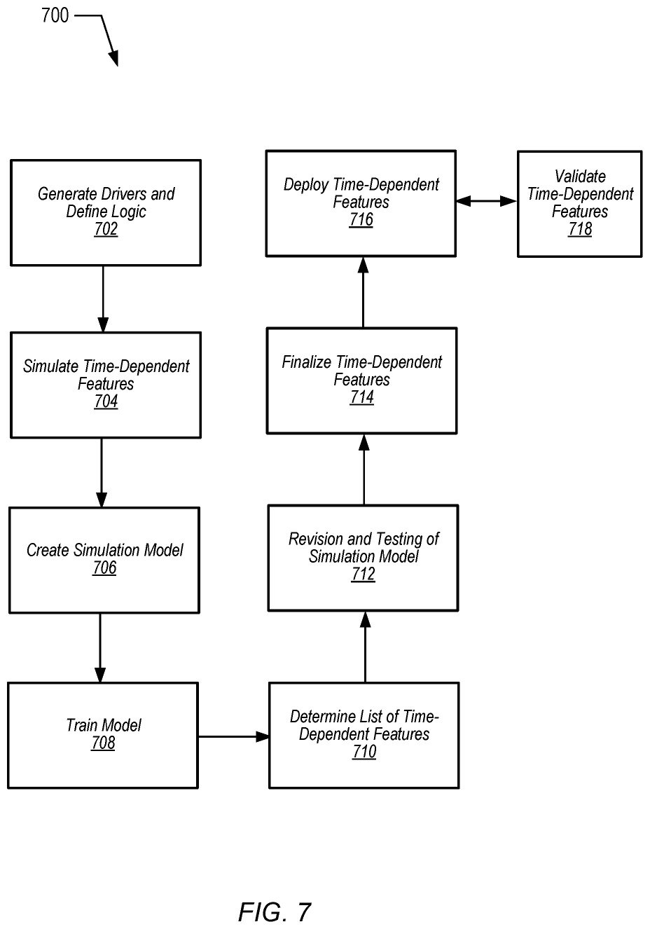

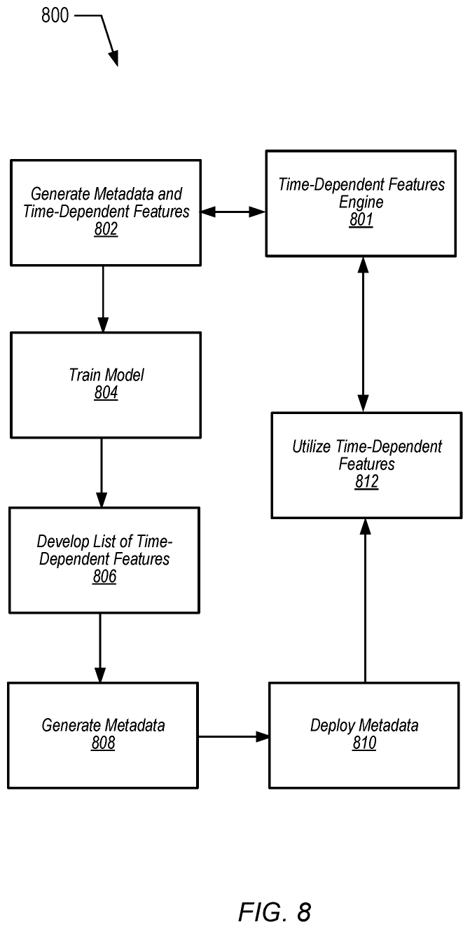

FIG. 7 depicts a flow diagram illustrating a method for implementing time-dependent features in an existing data analysis model, according to some embodiments. In the illustrated embodiment, method 700 begins with generating a set of drivers and defining logic for a programming language service (such as Spark) that will implement the time-dependent features in 702. In 704, the time-dependent features may be simulated for a model training process. In 706, a simulation model may be created in the programming language service. In 708, a model leveraging time-dependent features may be trained to refine the simulated time-dependent features. Training of the model may determine a list of time-dependent features in 710. In some embodiments, further revision and testing of the simulation model may be implemented in 712 based on the list of time-dependent features. Further revision and testing may eventually lead to finalization of the time-dependent features in 714. The finalized time-dependent features may then be deployed to existing data analysis models in 716 (e.g., deployed to production). In some embodiments, time-dependent features deployed and in production may be validated in 718.

In certain embodiments, a time-dependent (e.g., slope) features engine may be developed in the programming language that can be utilized for additional implementation of time-dependent features in data analysis existing models. FIG. 8 depicts a flow diagram illustrating a method for implementing time-dependent features in an existing data analysis model with a time-dependent features engine, according to some embodiments. The time-dependent features engine may be developed based on the deployed time-dependent features developed by method 700, shown in FIG. 7. In the illustrated embodiment of FIG. 8, method 800 begins with the generation of metadata and simulated time-dependent features in 802. In some embodiments, the metadata and simulated time-dependent features are generated in associated with the time-dependent features engine in 801. In 804, a model leveraging time-dependent features may be trained to refine the simulated time-dependent features and develop a list of time-dependent features in 806. From the list of time-dependent features, metadata may be generated in 808 and deployed to production in 810. Generating the metadata in 808 may include refining of the metadata generated in 802. The deployed metadata in 810 may be utilized in combination with the time-dependent features engine 801 to enable utilization of time-dependent features in existing data analysis models in 812.

Methods 700 and 800 depicted in FIGS. 7 and 8, respectively, are provided as examples for implementation of time-dependent features in existing data analysis models utilizing a programming language service. These examples provide for relatively easy adoption of time-dependent features into existing data analysis models. Other methods for adoption of time-dependent features into existing data analysis models may also be contemplated in order to provide the described advantages of implementing time-dependent features in analysis of temporally spaced data.

### Example Methods

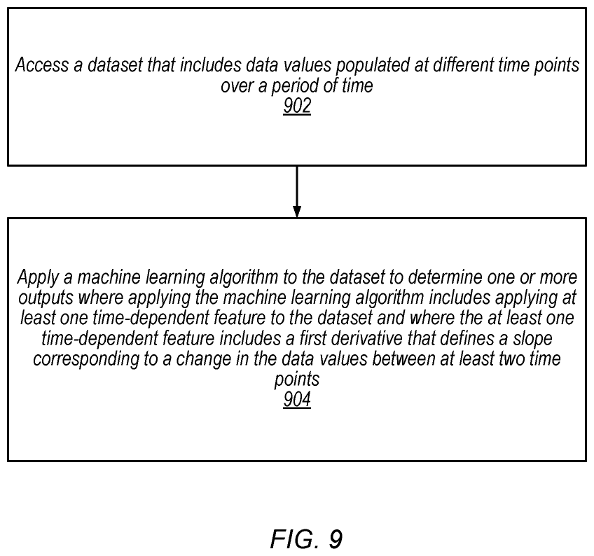

FIG. 9 is a flow diagram illustrating a method for applying time-dependent features in analysis of temporally spaced data by a machine learning algorithm, according to some embodiments. The method shown in FIG. 9 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system, such as computing device 1010, described below.

At 902, in the illustrated embodiment, a computer system accesses a dataset that includes data values populated at different time points over a period of time. In some embodiments, the dataset that includes data values populated at temporally spaced data points. In some embodiments, the dataset that includes data values populated at a plurality of temporally spaced data points during a period of time.

At 904, in the illustrated embodiment, the computer system applies a machine learning algorithm to the dataset to determine one or more outputs where applying the machine learning algorithm includes applying at least one time-dependent feature to the dataset and where the at least one time-dependent feature includes a first derivative that defines a slope corresponding to a change in the data values between at least two time points.

In some embodiments, the at least one time-dependent feature includes at least one additional first derivative that defines a slope corresponding to a change in the data values between at least two additional time points. In some embodiments, the first derivative corresponds to a first time window in the period of time and the additional first derivative corresponds to a second time window in the period of time, the second time window being different from the first time window. The second time window may be adjacent to the first time window. In some embodiments, the at least one time-dependent feature includes a second derivative that defines a change in the slope between the first derivative and the at least one additional first derivative.

In some embodiments, the at least two time points for the first derivative are defined by a hyperparameter applied to the machine learning algorithm. In some embodiments, a paths hyperparameter is applied to the machine learning algorithm where the number of paths hyperparameter defines a set of categories for the first derivative. The set of categories may include categories that correspond to performance characteristics for the first derivative. In some embodiments, an overlapping window hyperparameter is applied to the machine learning algorithm where the overlapping window hyperparameter defines an overlap in time between a first time window for the first derivative and a second time window for at least one additional first derivative.

### Example Computer System

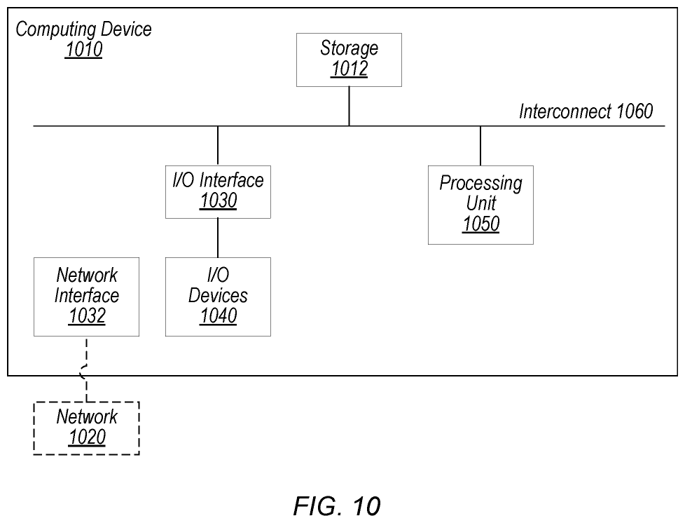

Turning now to FIG. 10, a block diagram of one embodiment of computing device (which may also be referred to as a computing system) 1010 is depicted. Computing device 1010 may be used to implement various portions of this disclosure. Computing device 1010 may be any suitable type of device, including, but not limited to, a personal computer system, desktop computer, laptop or notebook computer, mainframe computer system, web server, workstation, or network computer. As shown, computing device 1010 includes processing unit 1050, storage 1012, and input/output (I/O) interface 1030 coupled via an interconnect 1060 (e.g., a system bus). I/O interface 1030 may be coupled to one or more I/O devices 1040. Computing device 1010 further includes network interface 1032, which may be coupled to network 1020 for communications with, for example, other computing devices.

In various embodiments, processing unit 1050 includes one or more processors. In some embodiments, processing unit 1050 includes one or more coprocessor units. In some embodiments, multiple instances of processing unit 1050 may be coupled to interconnect 1060. Processing unit 1050 (or each processor within 1050) may contain a cache or other form of on-board memory. In some embodiments, processing unit 1050 may be implemented as a general-purpose processing unit, and in other embodiments it may be implemented as a special purpose processing unit (e.g., an ASIC). In general, computing device 1010 is not limited to any particular type of processing unit or processor subsystem.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Storage 1012 is usable by processing unit 1050 (e.g., to store instructions executable by and data used by processing unit 1050). Storage 1012 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage 1012 may consist solely of volatile memory, in one embodiment. Storage 1012 may store program instructions executable by computing device 1010 using processing unit 1050, including program instructions executable to cause computing device 1010 to implement the various techniques disclosed herein.

I/O interface 1030 may represent one or more interfaces and may be any of various types of interfaces configured to couple to and communicate with other devices, according to various embodiments. In one embodiment, I/O interface 1030 is a bridge chip from a front-side to one or more back-side buses. I/O interface 1030 may be coupled to one or more I/O devices 1040 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
accessing, by a computer system, a dataset that includes data values populated at different time points over a period of time; and
applying a machine learning algorithm to the dataset to determine one or more outputs, wherein applying the machine learning algorithm includes applying at least one time-dependent feature to the dataset, wherein the at least one time-dependent feature includes a first derivative that defines a slope corresponding to a change in the data values between at least two time points.

2. The method of claim 1, wherein the at least one time-dependent feature includes at least one additional first derivative that defines a slope corresponding to a change in the data values between at least two additional time points.

3. The method of claim 2, wherein the first derivative corresponds to a first time window in the period of time and the additional first derivative corresponds to a second time window in the period of time, the second time window being different from the first time window.

4. The method of claim 3, wherein the second time window is adjacent to the first time window.

5. The method of claim 2, wherein the at least one time-dependent feature includes a second derivative that defines a change in the slope between the first derivative and the at least one additional first derivative.

6. The method of claim 1, wherein the at least two time points for the first derivative are defined by a hyperparameter applied to the machine learning algorithm.

7. The method of claim 1, further comprising applying a paths hyperparameter to the machine learning algorithm, wherein the paths hyperparameter defines a set of categories for the first derivative.

8. The method of claim 7, wherein the set of categories includes categories that correspond to performance characteristics for the first derivative.

9. The method of claim 1, further comprising applying an overlapping window hyperparameter to the machine learning algorithm, wherein the overlapping window hyperparameter defines an overlap in time between a first time window for the first derivative and a second time window for at least one additional first derivative.

10. The method of claim 1, wherein the one or more outputs of the machine learning algorithm includes a classification category output or a predictive output.

11. A non-transitory computer-readable medium having instructions stored thereon that are executable by a computing device to perform operations, comprising:
accessing, by a computer system, a dataset that includes data values populated at temporally spaced data points; and
applying a machine learning algorithm to the dataset to determine one or more outputs, wherein applying the machine learning algorithm includes applying at least one time-dependent feature to the dataset, wherein the at least one time-dependent feature includes a first derivative that defines a slope corresponding to a change in the data values over at least one time window, the at least one time window being a time window between at least two temporally spaced data points.

12. The computer-readable medium of claim 11, wherein the at least one time-dependent feature includes at least one additional first derivative that defines a slope corresponding to a change in the data values over at least one additional time window, wherein the at least one additional time window is a time window between at least two additional temporally spaced data points.

13. The computer-readable medium of claim 12, wherein one data point of the at least two temporally spaced data points is a same data point as one data point of the at least two additional temporally spaced data points.

14. The computer-readable medium of claim 12, wherein one data point of the at least two additional temporally spaced data points is a data point at a point in time between the at least two temporally spaced data points.

15. The computer-readable medium of claim 12, wherein the at least one time-dependent feature includes a second derivative that defines a change in the slope between the at least one time window and the at least one additional time window.

16. The computer-readable medium of claim 11, wherein the at least one time-dependent feature includes a plurality of first derivatives that define slopes corresponding to changes in the data values over a plurality of time windows, and wherein the at least one time-dependent feature includes a total number of derivative levels that is one less than a total number of time windows.

17. A method, comprising:
accessing, by a computer system, a dataset that includes data values populated at a plurality of temporally spaced data points during a period of time; and
applying a machine learning algorithm to the dataset to determine one or more outputs, wherein applying the machine learning algorithm includes:
applying at least one aggregate feature to the dataset, wherein the at least one aggregate feature corresponds to an absolute value determined from assessment of the data values over the period of time; and
applying at least one time-dependent feature to the dataset, wherein the at least one time-dependent feature includes a first derivative that defines a slope corresponding to a change in the data values between at least two temporally spaced data points.

18. The method of claim 17, wherein the at least one time-dependent feature includes at least one additional first derivative that defines a slope corresponding to a change in the data values between at least two different temporally spaced data points.

19. The method of claim 17, wherein the absolute value for the at least one aggregate feature is an average value for the data values determined over the period of time.

20. The method of claim 17, wherein the absolute value for the at least one aggregate feature is a maximum or a minimum value of the data values during the period of time.
